(19) United States
(12) Patent Application Publication
(10) Pub. No.: US 2026/0298462 A1
(43) Pub. Date: Oct. 1, 2026

(54) COOLING FAN WITH LIGHT GUIDE ELEMENTS

(71) Applicants: DONGGUAN CITY HANSHUO PLASTIC CO.,LTD, DONGGUAN (CN); EVERFLOW TECHNOLOGY CORP., NEW TAIPEI (CN)

(72) Inventors: KAOKUNG CHIU, DONGGUAN (CN); JIANXIN HUANG, DONGGUAN (CN); XIAORONG LIU, DONGGUAN (CN)

(21) Appl. No.: 19/421,061

(22) Filed: Dec. 16, 2025

(30) Foreign Application Priority Data
Mar. 26, 2025 (CN) 202520563202.0
Mar. 26, 2025 (CN) 202520563211.X
Mar. 26, 2025 (CN) 202520563280.0

(51) Int. Cl. F21V 33/00; F21Y 113/00; F21Y 115/10

(52) U.S. Cl. CPC F21V 33/0096; F21Y 2113/00; F21Y 2115/10

(57) ABSTRACT

A cooling fan with a luminous effect includes a fan body. The fan body includes a fan blade structure, light guide elements and an LED module. The fan blade structure includes blades and a central hub. Each of the blades includes a first surface and a second surface. The light guide elements include light-emitting points and light-receiving points. Each of the light guide elements extends along and passes through the first surface of a corresponding one of the blades, and forms a corresponding one of the light-emitting points on the second surface of the corresponding one of the blades. One end of each of the light guide elements forms a corresponding one of the light-receiving points. The LED module includes LED lamp beads. The light-receiving points receive light emitted by the LED lamp beads and transmit the light to the light-emitting points.

### TECHNICAL FIELD

The present disclosure relates to a technical field of cooling fans, and in particular to a cooling fan with a luminous effect.

### BACKGROUND

When a computer is running, internal electronic chips generate a lot of heat. Due to continuous upgrading of modern computer equipment, a processing speed of internal electronic chips is extremely high, and the heat generated by the internal electronic chips is unable to be dissipated through natural air convection. Therefore, a cooling fan is introduced to assist in heat dissipation of the internal electronic chips and prevents the computer from crashing due to overheating.

In addition, with rapid development of computer and information technology, computer design, especially a design of cooling fans, is constantly evolving. People not only need cooling fans with excellent heat dissipation capabilities and stable structures, but also have increasingly higher requirements for outer structures and visual effects of the cooling fans. However, conventional cooling fans only have a heat dissipation function but have poor noise reduction performance and overly simplistic functionality, which are difficult to realize ideal dynamic visual effects.

### SUMMARY

In view of defects in the prior art, the present disclosure provides a cooling fan with a luminous effect. The cooling fan has multiple functions and has a good visual experience. The cooling fan comprises a fan body. The fan body comprises a fan blade structure, light guide elements and a light-emitting diode (LED) module. The fan blade structure comprises a central hub and blades extending outward from an outer wall of the central hub. The central hub defines a cavity. Each of the blades comprises a first surface and a second surface disposed opposite to the first surface. The light guide elements comprise light-emitting points and light-receiving points. A first end of each of the light guide elements is away from the central hub. Each of the light guide elements extends along the first surface of a corresponding one of the blades, passes through the corresponding one of the blades and forms a corresponding one of the light-emitting points on the second surface of the corresponding one of the blades. Each of the light-receiving points is disposed on a second end of a corresponding one of the light guide elements. The second end of each of the light guide elements faces the central hub. The LED module comprises LED lamp beads. The LED lamp beads are one-to-one corresponding to the light-receiving points of the light guide elements. The light-receiving points are configured to receive light emitted by the LED lamp beads and transmit the light to the light-emitting points.

Alternatively, the cooling fan comprises a fan body. The fan body comprises a fan blade structure, light guide elements and an LED module. The fan blade structure comprises a central hub and blades extending outward from an outer wall of the central hub. The central hub defines a cavity. Each of the blades comprises a first surface and a second surface disposed opposite to the first surface. A first end of each of the light guide elements is away from the central hub. The light guide elements comprises light-emitting points and light-receiving points. Each of the light guide elements extends along the first surface of a corresponding one of the blades to form a corresponding one of the light-emitting points. The first surface of each of the blades is an arc-shaped curved surface. Each of the light guide elements extends along a bending direction of the arc-shaped curved surface of the corresponding one of the blades. Each of the light-receiving points is disposed on a second end of a corresponding one of the light guide elements. The second end of each of the light guide elements faces the central hub. The LED module is accommodated in the cavity. The LED module comprises LED lamp beads. The LED lamp beads are one-to-one corresponding to the light-receiving points of the light guide elements. The light-receiving points are configured to receive light emitted by the LED lamp beads.

The cooling fan features a dynamic luminous visual effect through the light guide elements, the LED lamp beads, and a light path conduction design. The central hub and the fixing bracket ensure operating stability of the cooling fan and makes the cooling fan easy to install. The cooling fan combines characteristics of optimized heat dissipation performance, noise control, decorative lighting, and stable installation, thereby enhancing overall competitiveness of the cooling fan and making it suitable for electronic devices having requirements for heat dissipation, quiet operation, and aesthetics.

### BRIEF DESCRIPTION OF DRAWINGS

FIG. 1 is a schematic diagram of a cooling fan with a luminous effect according to a first embodiment of the present disclosure.

FIG. 2 is an exploded schematic diagram of the cooling fan shown in FIG. 1.

FIG. 3 is another schematic diagram of the cooling fan shown in FIG. 1.

FIG. 4 is a schematic diagram of a fixing bracket of the cooling fan shown in FIG. 1.

FIG. 5 is a schematic diagram of the cooling fan according to a second embodiment of the present disclosure.

FIG. 6 is an exploded schematic diagram of the cooling fan shown in FIG. 5.

FIG. 7 is a schematic diagram of a fan blade structure of the cooling fan shown in FIG. 5.

FIG. 8 is a schematic diagram of a fixing bracket of the cooling fan shown in FIG. 5.

FIG. 9 is a schematic diagram of the cooling fan according to a third embodiment of the present disclosure.

FIG. 10 is an enlarged schematic diagram of portion A of the cooling fan shown in FIG. 9.

FIG. 11 is an exploded schematic diagram of the cooling fan shown in FIG. 9.

FIG. 12 is another schematic diagram of the cooling fan shown in FIG. 9.

FIG. 13 is a block diagram of a working principle of the cooling fan shown in FIG. 9.

### DETAILED DESCRIPTION

In order to make objectives, technical solutions, and advantages of the embodiments of the present disclosure clear, technical solutions in the embodiments of the present disclosure will be described clearly and completely in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

### Embodiment 1

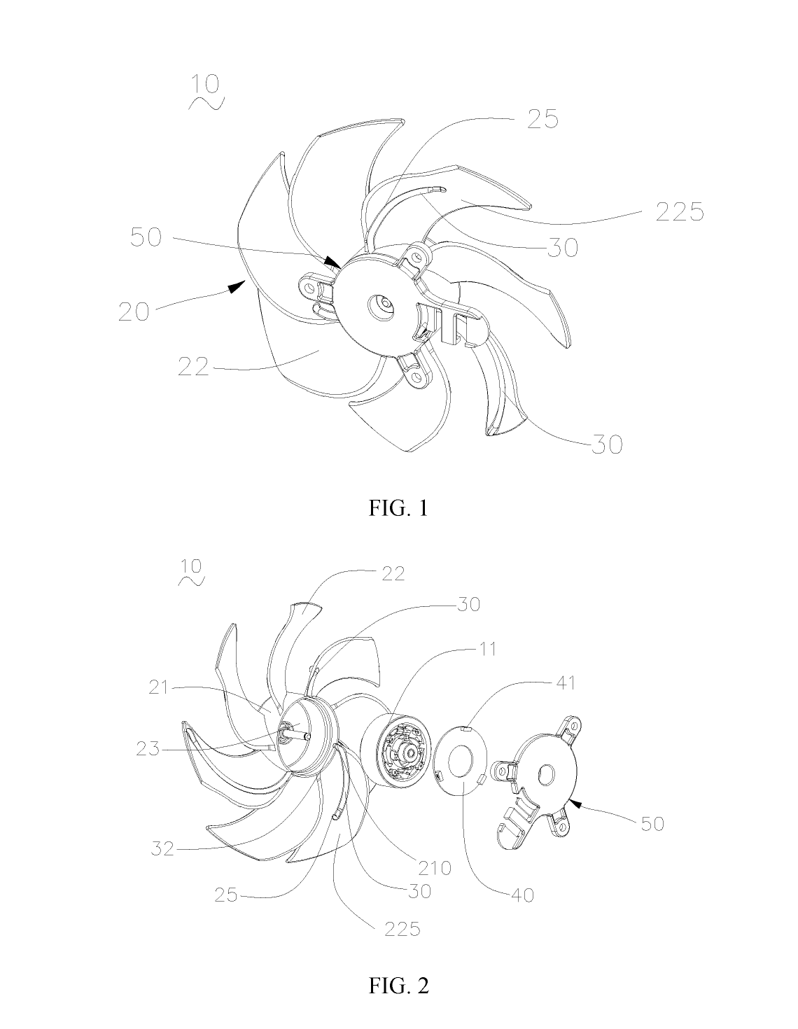

As shown in FIGS. 1-4, the first embodiment of the present disclosure provides a cooling fan with a luminous effect. The cooling fan comprises a fan body 10. The fan body 10 comprises a fan blade structure 20, light guide elements 30 and a light-emitting diode (LED) module 40. The fan blade structure 20 comprises a central hub 21 and blades 22 extending outward from an outer wall of the central hub 21. The central hub 21 is a hollow shell. The central hub 21 defines a cavity 23. The LED module 40 is accommodated in the cavity 23. Each of the blades 22 comprises a first surface 225 and a second surface 226 disposed opposite to the first surface 225. The light guide elements 30 comprise light-emitting points 31 and light-receiving points 32. A first end of each of the light guide elements 30 is away from the central hub 21. Each of the light guide elements 30 extends along the first surface 225 of a corresponding one of the blades 22, and passes through the corresponding one of the blades 22 and forms a corresponding one of the light-emitting points 31 on the second surface 226 of the corresponding one of the blades 22. In other words, a second end of each of the light guide elements 30 is disposed in the cavity 23 to receive light emitted by the LED module 40.

In the embodiment, the light guide elements 30 are mounted on a portion of the blades 22. Specifically, there are seven blades 22 and three light guide elements 30. That is, each of the light guide elements 30 is disposed on one of each adjacent two blades 22. It is understood that in other embodiments, the number of the light guide elements 30 is adjusted as needed. For example, there may be only one light guide element 30, or there may be seven light guide elements 30 ( i.e., the light guide elements 30 are one-to-one disposed on the blades 22).

The first surface 225 of each of the blades 22 is an arc-shaped curved surface, and each of the light guide elements 30 extends along a bending direction of the arc-shaped curved surface of the corresponding one of the blades 22. Each of the light-receiving points 32 is disposed on the second end of a corresponding one of the light guide elements 30. The second end of each of the light guide elements 30 faces the central hub 21. The light-receiving points 32 are disposed in the cavity 23 to receive the light emitted by the LED module 40. The light guide elements 30 further comprise light shielding sleeves (Not shown in the drawings). Each of the light shielding sleeves is sleeved on an extension portion of a corresponding one of the light guide elements 30, and the extension portion of each of the light guide elements 30 is a portion of each of the light guide elements 30 located on the first surface 225 of the corresponding one of the blades 22. The LED module 40 comprises a circuit board and the LED lamp beads 41 mounted on the circuit board. The LED lamp beads 41 are one-to-one corresponding to the light-receiving points 32 of the light guide elements 30. In the embodiment, the LED lamp beads 41 are disposed on an outer surface of the circuit board facing away from the cavity 23.

Specifically, lengths of the light guide elements 30 may be different. The second end of each of the light guide elements 30, defining the corresponding one of the light-receiving points 32, passes through the central hub 21. Each of the light guide elements 30 extends along the first surface 225 of the corresponding one of the blades 22. The first end of each of the light guide elements passes through the corresponding one of the blades 22 and forms the corresponding one of the light-emitting points 31 on the second surface 226 of the corresponding one of the blades 22. Specifically, the central hub 21 comprises notches 210 communicated with the cavity 23. The notches 210 are configured to accommodate the light-receiving points 32 of the light guide elements 30. In other words, the second end of each of the light guide elements is accommodated in a corresponding one of the notches. Such a diverse light guide method creates rich luminous effects, meeting different decorative and visual needs. Each of the light guide elements 30 extends along the bending direction of the first surface 225 of the corresponding one of the blades 22, so that the light guide elements 30 well fit with the fan blade structure 20, which ensures integrity and aesthetics of the cooling fan while reducing light refraction loss due to misfitting, thus improving light guiding efficiency. Each of the light shielding sleeves is disposed at the extension of the corresponding one of the light guide elements 30 along the first surface 225 of the corresponding one of the blades 22, which effectively prevent light from leaking from two sides of each of the blades. Therefore, the light is more concentrated and spreads along the light guide elements 30, enhancing the brightness and clarity of the light at the light-emitting points 31 and improving the overall visual effect of the cooling fan.

As shown in FIG. 1, the blades 22 are evenly disposed around the central hub 21. Specifically, a circumferential uniform distribution design of the blades 22 around the central hub 21ensures rotational balance.

As shown in FIG. 3, noise reduction ribs 24 are disposed on the second surface 226 of each of the blades 22, and the noise reduction ribs 24 on each of the blades 22 are distributed at intervals along an extension direction of each of the blades 22. Specifically, the blades 22 comprise the noise-reduction ribs disposed at intervals to reduce vortex noise by disrupting airflow. Combined with an airfoil blade design, wind resistance and operating noise are reduced.

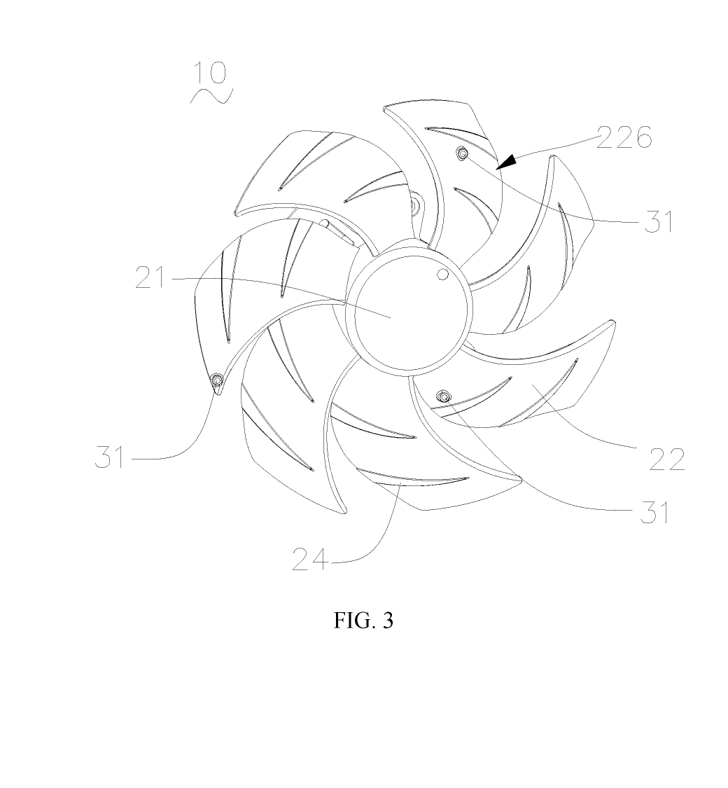

As shown in FIG. 2, the first surface 225 of each of the blades 22 equipped with a corresponding one of the light guide elements 30 defines a mounting groove 25. Each mounting groove 25 is disposed along an extension direction of a corresponding one of the blades 22. Each mounting groove 25 is configured to accommodate a corresponding one of the light guide elements 30 and implement light transmission.

Specifically, each mounting groove 25 secures the corresponding one of the light guide elements 30, preventing rotational displacement of the corresponding one of the light guide elements 30 and ensuring stability of the light transmission. In other embodiments, each of the light guide elements 30 is directly bonded to the corresponding one of the blades 22 through adhesive.

The LED lamp beads 41 are disposed in an annular array, and the LED lamp beads 41 are adjusted by an external control circuit board (not shown in the drawings). Light emission directions of the LED lamp beads 41 respectively match light guiding directions of the light guide elements 30. The LED lamp beads 41 are connected to the light receiving points 32. Specifically, an annular array distribution of the LED lamp beads 41 improves uniformity of light guiding, meets needs of diverse scenarios, and enhances personalization and technological feel of the cooling fan. Through the external control circuit board, an emission color, a brightness, a flicker frequency and other parameters of the LED lamp beads 41 are effectively adjusted to improve the visual effects. The LED lamp beads 41 uniformly provide the light to the light guide elements 30, ensuring uniform brightness of the light guide elements 30, avoiding large differences in brightness, and improving an overall light emission quality.

The fan body 10 further comprises a driving module 11 mounted in the cavity 23. The driving module 11 is configured to drive the fan blade structure 20 to rotate. The driving module 11 comprises an output shaft connected to the central hub 21. The central hub 21 is configured for power transmission between the fan blade structure 20 and the driving module 11. Specifically, the central hub 21 is connected to the output shaft of the driving module 11 to ensure stable power transmission and ensure rotation reliability of the fan blade structure 20. In the embodiment, the driving module 11 is a brushless motor or other driving device.

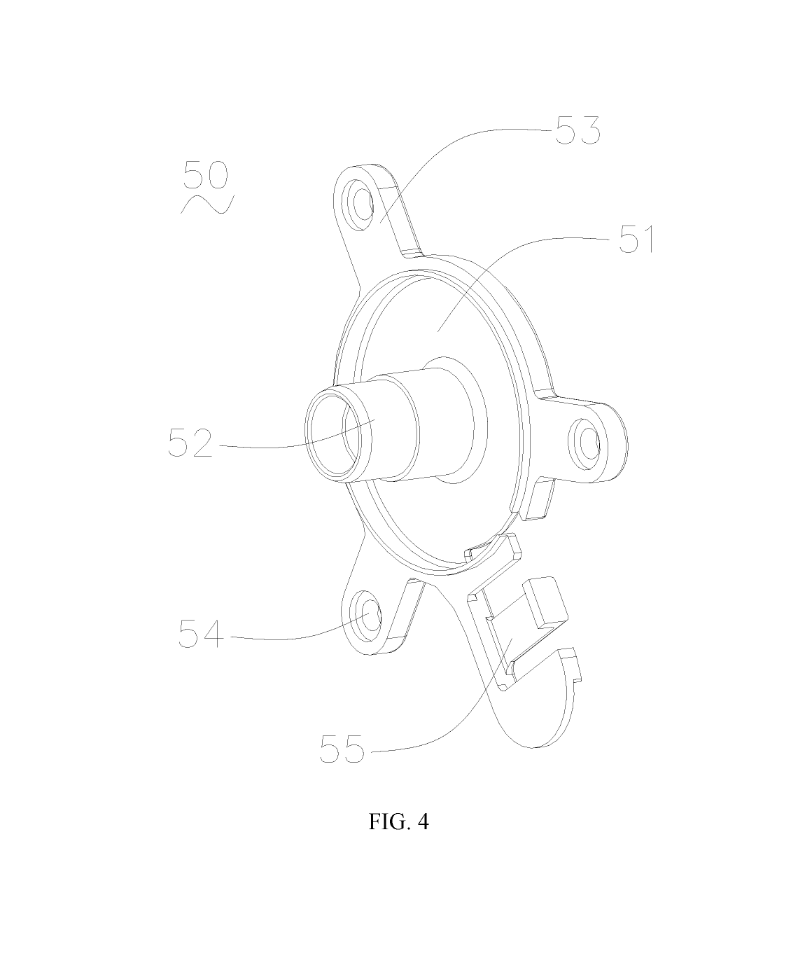

As shown in FIG. 4, the fan body 10 further comprises a fixing bracket 50. The fixing bracket 50 comprises a circular base plate 51, an assembling cylinder 52, and mounting support arms 53. A center of the circular base plate 51 is connected to the assembling cylinder 52. The assembling cylinder 52 is matched with the driving module 11. The driving module is axially positioned with the assembling cylinder 52 by an interference fit or a key connection. The mounting support arms 53 are connected to an outer edge of the circular base plate 51. Specifically, a design of the circular base plate 51, the assembling cylinder 52, and the mounting support arms 53 of the fixing bracket 50 enables precise assembly of the fixing bracket with the driving module 11. The mounting support arms 53 are configured to an external fixed structure, thereby improving overall structural stability of the cooling fan.

The mounting support arms 53 comprise at least three mounting support arms 53. The at least three mounting support arms 53 are distributed in a circular array. An end of each of the mounting support arms 53 defines a mounting through hole 54. Each mounting through hole 54 is configured to be fastened and mounted by a screw. Specifically, the at least three mounting support arms 53 are disposed in the circular array to distribute fixed force points. Each mounting through hole 54 is configured to fasten the screw, which improves mounting stability of the cooling fan and prevents the cooling fan from loosening due to vibration.

A snapping structure 55 is disposed on one side of the circular base plate 51. The snapping structure is configured to connect with the external control circuit board to limit a position of the external control circuit board.

Specifically, the snapping structure 55 cooperates with the external control circuit board to realize rapid positioning and mounting of the cooling fan, thereby simplifying an assembly process, compacting a layout, saving space and improving integration of the cooling fan.

It is understood that in other embodiments, the first end of each of the light guide elements 30 passes through the cavity 23 of the central hub 21 and extends along the first surface 225 of the corresponding one of the blades 22, without passing through the first surface 225 of the corresponding one of the blades 22, but instead directly forms the corresponding one of the light-emitting points 31 on the first surface 225 of the corresponding one of the blades.

### Embodiment 2

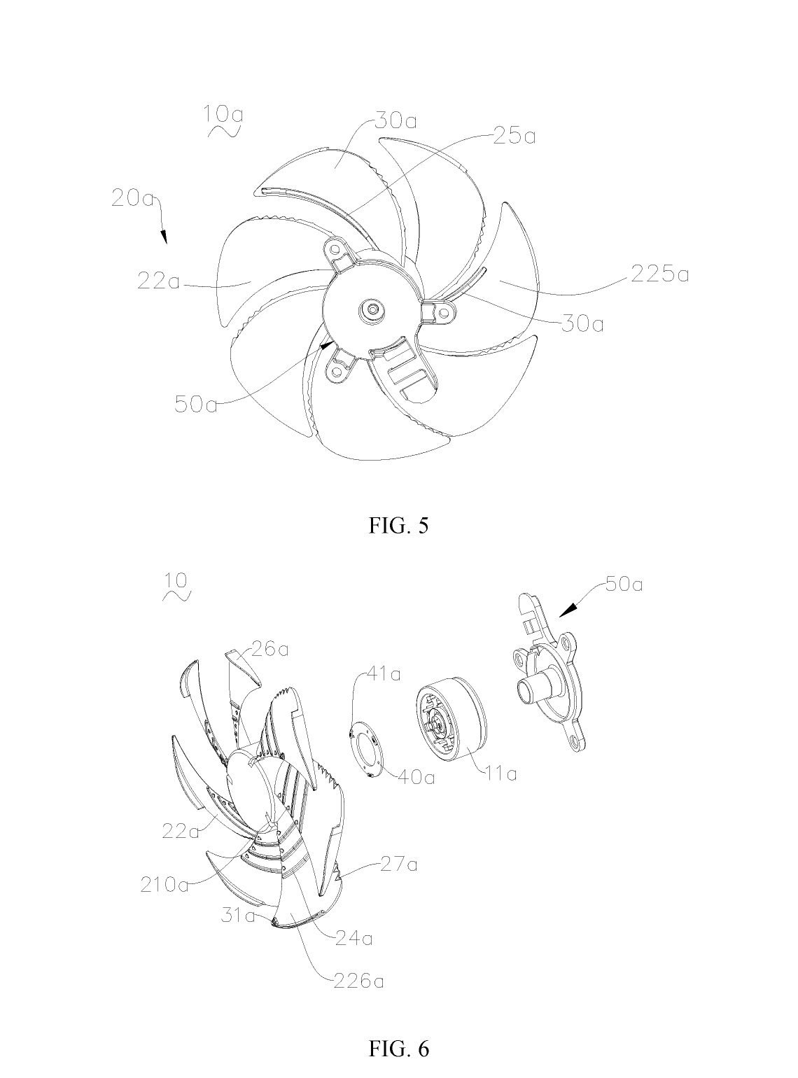

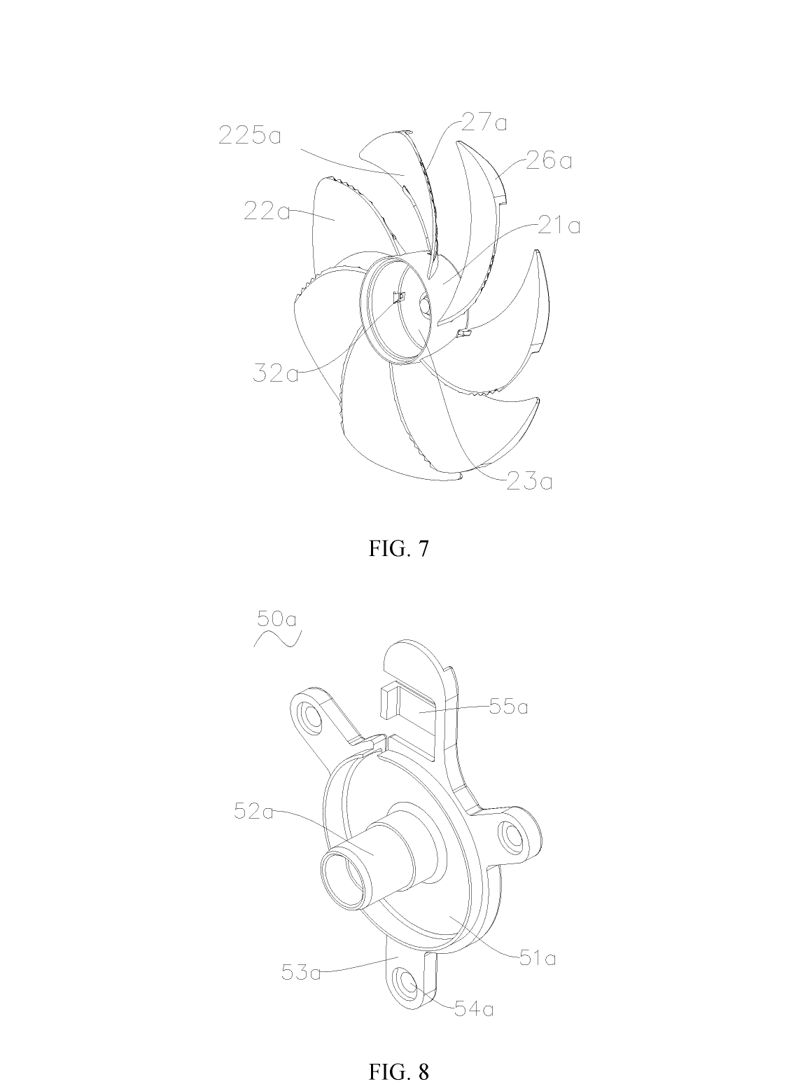

As shown in FIGS. 5-8, the second embodiment of the present disclosure provides a cooling fan with a luminous effect. The cooling fan comprises a fan body 10a. The fan body 10acomprises a fan blade structure 20a, light guide elements 30a and an LED module 40a. The fan blade structure 20acomprises a central hub 21a and blades 22a extending outward from an outer wall of the central hub 21a. The central hub 21ais a hollow shell. The central hub 21adefines a cavity 23a. The LED module 40ais accommodated in the cavity 23a. Each of the blades 22acomprises a first surface 225a and a second surface 226a disposed opposite to the first surface 225a. The light guide elements 30acomprise light-emitting points 31aand light-receiving points 32a. A first end of each of the light guide elements 30ais away from the central hub 21a. Each of the light guide elements 30aextends along the first surface 225a of a corresponding one of the blades 22a, and passes through the corresponding one of the blades 22aand forms a corresponding one of the light-emitting points 31a on the second surface 226a of the corresponding one of the blades 22a. In other words, a second end of each of the light guide elements 30a is disposed in the cavity 23a to receive light emitted by the LED module 40a.

In the embodiment, the light guide elements 30a are mounted on a portion of the blades 22a. Specifically, there are seven blades 22aand three light guide elements 30a. That is, each of the light guide elements 30ais disposed on one of each adjacent two blades 22a. It is understood that in other embodiments, the number of the light guide elements 30a is adjusted as needed. For example, there may be only one light guide element 30, or there may be seven light guide elements 30a(i.e., the light guide elements 30aare one-to-one disposed on the blades 22a).

The first surface 225a of each of the blades 22ais an arc-shaped curved surface, and each of the light guide elements 30aextends along a bending direction of the arc-shaped curved surface of the corresponding one of the blades 22a. Each of the light-receiving points 32ais disposed on the second end of a corresponding one of the light guide elements 30a. The second end of each of the light guide elements 30a faces the central hub 21a. The light-receiving points 32aare disposed in the cavity 23ato receive the light emitted by the LED module 40a. The light guide elements 30afurther comprise light shielding sleeves (not shown in the drawings). Each of the light shielding sleeves is sleeved on an extension portion of a corresponding one of the light guide elements 30a, and the extension portion of each of the light guide elements 30a is a portion of each of the light guide elements 30a located on the first surface 225a of the corresponding one of the blades 22a. The LED module 40acomprises a circuit board and the LED lamp beads 41a mounted on the circuit board. The LED lamp beads 41aare one-to-one corresponding to the light-receiving points 32aof the light guide elements 30a. Differing from the first embodiment, the LED lamp beads 41a are disposed on an inner surface of the circuit board facing away from the cavity 23a.

Specifically, lengths of the light guide elements 30a may be different. The second end of each of the light guide elements 30a, defining the corresponding one of the light-receiving points 32a, passes through the central hub 21a. Each of the light guide elements 30aextends along the first surface 225a of the corresponding one of the blades 22a. The first end of each of the light guide elements passes through the corresponding one of the blades 22aand forms the corresponding one of the light-emitting points 31a on the second surface 226a of the corresponding one of the blades 22a. Specifically, the central hub 21acomprises notches 210a communicated with the cavity 23a. The notches 210aare configured to accommodate the light-receiving points 32a of the light guide elements 30a. In other words, the second end of each of the light guide elements is accommodated in a corresponding one of the notches 210a. In the embodiment, each of the light guide elements 30a passes through the corresponding one of the notches 210a and enters the cavity 23a. Such a diverse light guide method creates rich luminous effects, meeting different decorative and visual needs. Each of the light guide elements 30aextends along the bending direction of the first surface 225a of the corresponding one of the blades 22a, so that the light guide elements 30a well fit with the fan blade structure 20a., which ensures integrity and aesthetics of the cooling fan while reducing light refraction loss due to misfitting, thus improving light guiding efficiency. Each of the light shielding sleeves is disposed at the extension of the corresponding one of the light guide elements 30a along the first surface 225a of the corresponding one of the blades 22a, which effectively prevent light from leaking from two sides of each of the blades. Therefore, the light is more concentrated and spreads along the light guide elements 30a, enhancing the brightness and clarity of the light at the light-emitting points 31a and improving the overall visual effect of the cooling fan.

Differing from the first embodiment, as shown in FIG. 6, a top portion of each of the blades 22a extends forwardly to form a protrusion portion 26a. Each protrusion portion 26a is of a streamlined curved structure. Sawtooth structures 27aconnected end to end are disposed on one side edge of each of the blades 22a and are adjacent to a corresponding protrusion portion 26a. The sawtooth structures 27aare disposed on a periphery of each of the blades 22a. Specifically, each protrusion portion 26a is streamlined, which optimizes the airflow direction, reduces vortex generation, and improves heat dissipation efficiency. The serrated structures 27acuts the airflow and disrupts an airflow vibration frequency, thereby realizing efficient noise reduction and enhancing heat dissipation performance.

As shown in FIG. 6, noise reduction ribs 24a are disposed on the second surface 226a of each of the blades 22a. The noise reduction ribs 24a of each of the blades are raised and distributed in an array. The noise reduction ribs 24aextend along a length direction of each of the blades 22a. Specifically, the noise reduction ribs 24adisposed in the array are raised to disrupt airflow turbulence, thereby reducing airflow friction noise. Further, the noise reduction ribs 24aextending along the length direction of the blades 22a expand a noise reduction range and improve quietness performance of the cooling fan.

As shown in FIG. 5, the first surface 225a of each of the blades 22a equipped with a corresponding one of the light guide elements 30a defines a mounting groove 25a. Each mounting groove 25ais disposed along an extension direction of a corresponding one of the blades 22a. Each mounting groove 25ais configured to accommodate a corresponding one of the light guide elements 30a and implement light transmission. Specifically, each mounting groove 25asecures the corresponding one of the light guide elements 30a, preventing rotational displacement of the corresponding one of the light guide elements 30a and ensuring stability of the light transmission. In other embodiments, each of the light guide elements 30a is directly bonded to the corresponding one of the blades 22a through adhesive.

As shown in FIG. 6, the LED lamp beads 41a are disposed in an annular array, and the LED lamp beads 41a are adjusted by an external control circuit board (not shown in the drawings). Light emission directions of the LED lamp beads 41arespectively match light guiding directions of the light guide elements 30a. The LED lamp beads 41aare connected to the light receiving points 32a. Specifically, an annular array distribution of the LED lamp beads 41a improves uniformity of light guiding, meets needs of diverse scenarios, and enhances personalization and technological feel of the cooling fan. Through the external control circuit board, an emission color, a brightness, a flicker frequency and other parameters of the LED lamp beads 41a are effectively adjusted to improve the visual effects. The LED lamp beads 41auniformly provide the light to the light guide elements 30a, ensuring uniform brightness of the light guide elements 30a, avoiding large differences in brightness, and improving an overall light emission quality.

The fan body 10a further comprises a driving module 11a mounted in the cavity 23a. The driving module 11a is configured to drive the fan blade structure 20a to rotate. The driving module 11a comprises an output shaft connected to the central hub 21a. The central hub 21ais configured for power transmission between the fan blade structure 20a and the driving module 11a. Specifically, the central hub 21a is connected to the output shaft of the driving module 11a to ensure stable power transmission and ensure rotation reliability of the fan blade structure 20a. In the embodiment, the driving module 11ais a brushless motor or other driving device.

As shown in FIG. 8, the fan body 10a further comprises a fixing bracket 50a. The fixing bracket 50acomprises a circular base plate 51a, an assembling cylinder 52a, and mounting support arms 53a. A center of the circular base plate 51ais connected to the assembling cylinder 52a. The assembling cylinder 52ais matched with the driving module 11a. The driving module is axially positioned with the assembling cylinder 52a by an interference fit or a key connection. The mounting support arms 53aare connected to an outer edge of the circular base plate 51a. Specifically, a design of the circular base plate 51a, the assembling cylinder 52a, and the mounting support arms 53a of the fixing bracket 50a enables precise assembly of the fixing bracket with the driving module 11a. The mounting support arms 53aare configured to an external fixed structure, thereby improving overall structural stability of the cooling fan.

The mounting support arms 53a comprise at least three mounting support arms 53a. The at least three mounting support arms 53aare distributed in a circular array. An end of each of the mounting support arms 53adefines a mounting through hole 54a. Each mounting through hole 54ais configured to be fastened and mounted by a screw. Specifically, the at least three mounting support arms 53a are disposed in the circular array to distribute fixed force points. Each mounting through hole 54ais configured to fasten the screw, which improves mounting stability of the cooling fan and prevents the cooling fan from loosening due to vibration.

A snapping structure 55a is disposed on one side of the circular base plate 51a. The snapping structure is configured to connect with the external control circuit board to limit a position of the external control circuit board.

Specifically, the snapping structure 55a cooperates with the external control circuit board to realize rapid positioning and mounting of the cooling fan, thereby simplifying an assembly process, compacting a layout, saving space and improving integration of the cooling fan.

It is understood that in other embodiments, the first end of each of the light guide elements 30a passes through the cavity 23a of the central hub 21a and extends along the first surface 225a of the corresponding one of the blades 22a, without passing through the first surface 225a of the corresponding one of the blades 22a, but instead directly forms the corresponding one of the light-emitting points 31 on the first surface 225a of the corresponding one of the blades.

### Embodiment 3

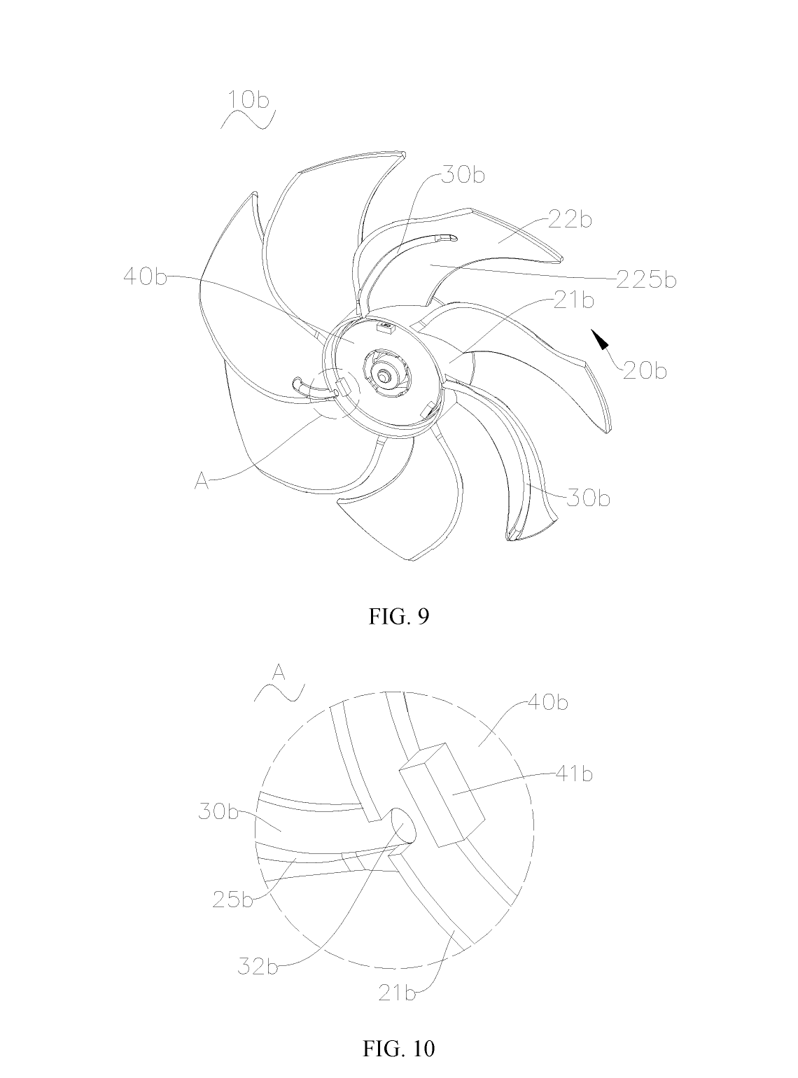

As shown in FIGS. 9-13, the third embodiment of the present disclosure provides a cooling fan with a luminous effect. The cooling fan comprises a fan body 10b. The fan body 10bcomprises a fan blade structure 20b, light guide elements 30b and an LED module 40b. The fan blade structure 20bcomprises a central hub 21b and blades 22b extending outward from an outer wall of the central hub 21b. The central hub 21bdefines a cavity 23b. The LED module 40bis accommodated in the cavity 23b. Each of the blades 22bcomprises a first surface 225b and a second surface 226b disposed opposite to the first surface 225b. The light guide elements 30bcomprise light-emitting points 31band light-receiving points 32b. A first end of each of the light guide elements 30bis away from the central hub 21b. Each of the light guide elements 30bextends along the first surface 225b of a corresponding one of the blades 22b, and passes through the corresponding one of the blades 22band forms a corresponding one of the light-emitting points 31b on the second surface 226b of the corresponding one of the blades 22b.

In the embodiment, the light guide elements 30b are mounted on a portion of the blades 22b. Specifically, there are seven blades 22band three light guide elements 30b. That is, each of the light guide elements 30bis disposed on one of each adjacent two blades 22b. It is understood that in other embodiments, the number of the light guide elements 30b is adjusted as needed. For example, there may be only one light guide element 30, or there may be seven light guide elements 30b(i.e., the light guide elements 30bare one-to-one disposed on the blades 22b).

The first surface 225b of each of the blades 22bis an arc-shaped curved surface, and each of the light guide elements 30bextends along a bending direction of the arc-shaped curved surface of the corresponding one of the blades 22b. Each of the light-receiving points 32bis disposed on the second end of a corresponding one of the light guide elements 30b. The second end of each of the light guide elements 30b faces the central hub 21b. The light-receiving points 32bare disposed in the cavity 23bto receive the light emitted by the LED module 40b. The light guide elements 30bfurther comprise light shielding sleeves (not shown in the drawings). Each of the light shielding sleeves is sleeved on an extension portion of a corresponding one of the light guide elements 30b, and the extension portion of each of the light guide elements 30b is a portion of each of the light guide elements 30b located on the first surface 225b of the corresponding one of the blades 22b. The LED module 40bcomprises a circuit board and the LED lamp beads 41b mounted on the circuit board. The LED lamp beads 41bare one-to-one corresponding to the light-receiving points 32bof the light guide elements 30b. Differing from the first embodiment, the LED lamp beads 41b are disposed on an outer surface of the circuit board facing away from the cavity 23b. Differing from the first embodiment, the cooling fan of the embodiment does not comprise the fixing bracket.

Specifically, lengths of the light guide elements 30b may be different. The second end of each of the light guide elements 30b, defining the corresponding one of the light-receiving points 32b, passes through the central hub 21b. Each of the light guide elements 30bextends along the first surface 225b of the corresponding one of the blades 22b. The first end of each of the light guide elements passes through the corresponding one of the blades 22band forms the corresponding one of the light-emitting points 31b on the second surface 226b of the corresponding one of the blades 22b. Specifically, the central hub 21bcomprises notches 210b communicated with the cavity 23b. The notches 210bare configured to accommodate the light-receiving points 32b of the light guide elements 30b. In other words, the second end of each of the light guide elements is accommodated in a corresponding one of the notches 210b. In the embodiment, each of the light guide elements 30b passes through the corresponding one of the notches 210b and enters the cavity 23b. Such a diverse light guide method creates rich luminous effects, meeting different decorative and visual needs. Each of the light guide elements 30b extends along the bending direction of the first surface 225b of the corresponding one of the blades 22b, so that the light guide elements 30b well fit with the fan blade structure 20b., which ensures integrity and aesthetics of the cooling fan while reducing light refraction loss due to misfitting, thus improving light guiding efficiency. Each of the light shielding sleeves is disposed at the extension of the corresponding one of the light guide elements 30b along the first surface 225b of the corresponding one of the blades 22b, which effectively prevent light from leaking from two sides of each of the blades. Therefore, the light is more concentrated and spreads along the light guide elements 30b, enhancing the brightness and clarity of the light at the light-emitting points 31b and improving an overall visual effect of the cooling fan.

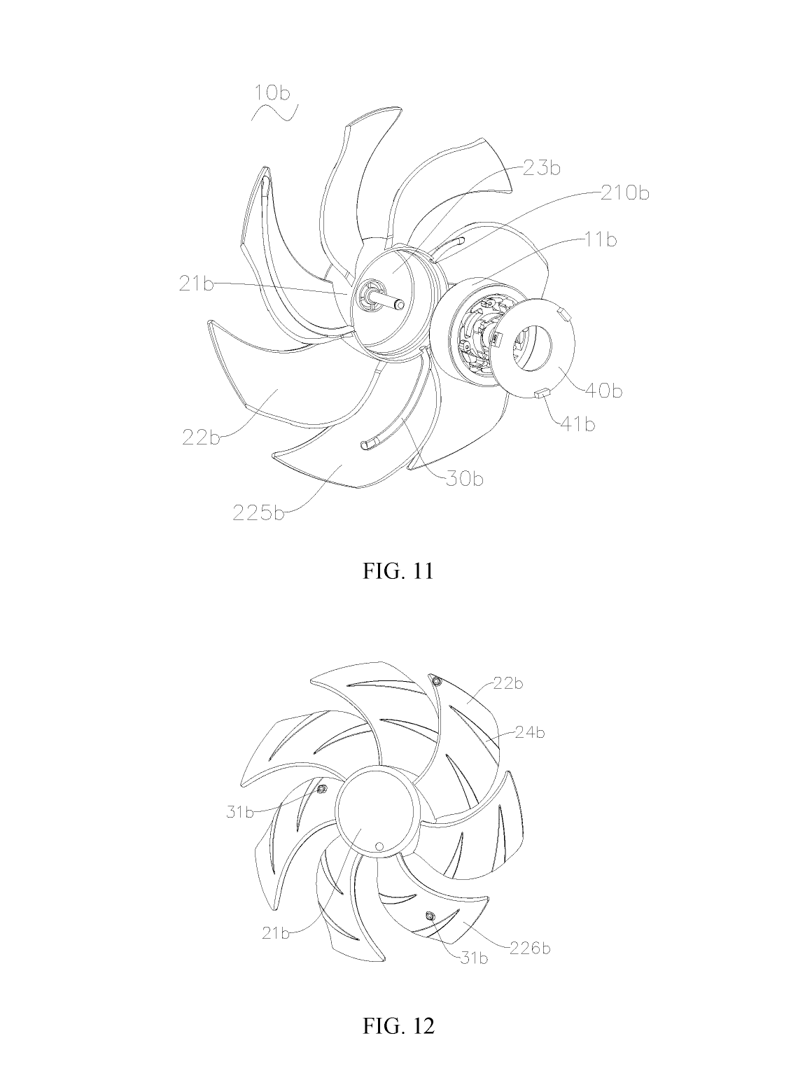

As shown in FIG. 12, noise reduction ribs 24b are disposed on the second surface 226b of each of the blades 22b, and the noise reduction ribs 24b on each of the blades 22b are distributed at intervals along an extension direction of each of the blades 22b. Specifically, the blades 22bcomprise the noise-reduction ribs 24b disposed at intervals to reduce vortex noise by disrupting airflow. Combined with an airfoil blade design, wind resistance and operating noise are reduced.

As shown in FIG. 10, the first surface 225b of each of the blades 22b equipped with a corresponding one of the light guide elements 30b defines a mounting groove 25b. Each mounting groove 25bis disposed along an extension direction of a corresponding one of the blades 22b. Each mounting groove 25bis configured to accommodate a corresponding one of the light guide elements 30b and implement light transmission. Specifically, each mounting groove 25bsecures the corresponding one of the light guide elements 30b, preventing rotational displacement of the corresponding one of the light guide elements 30b and ensuring stability of the light transmission. In other embodiments, each of the light guide elements 30b is directly bonded to the corresponding one of the blades 22b through adhesive.

The LED lamp beads 41b are disposed in an annular array, and the LED lamp beads 41b are adjusted by an external control circuit board (not shown in the drawings). Light emission directions of the LED lamp beads 41brespectively match light guiding directions of the light guide elements 30b. The LED lamp beads 41b are connected to the light receiving points 32b. Specifically, an annular array distribution of the LED lamp beads 41b improves uniformity of light guiding, meets needs of diverse scenarios, and enhances personalization and technological feel of the cooling fan. Through the external control circuit board, an emission color, a brightness, a flicker frequency and other parameters of the LED lamp beads 41b are effectively adjusted to improve the visual effects. The LED lamp beads 41b uniformly provide the light to the light guide elements 30b, ensuring uniform brightness of the light guide elements 30b, avoiding large differences in brightness, and improving an overall light emission quality.

As shown in FIG. 11, the fan body 10b further comprises a driving module 11b mounted in the cavity 23b. The driving module 11bis configured to drive the fan blade structure 20b to rotate. The driving module 11bcomprises an output shaft connected to the central hub 21b. The central hub 21bis configured for power transmission between the fan blade structure 20b and the driving module 11b. Specifically, the central hub 21bis connected to the output shaft of the driving module 11b to ensure stable power transmission and ensure rotation reliability of the fan blade structure 20b. In the embodiment, the driving module 11bis a brushless motor or other driving device.

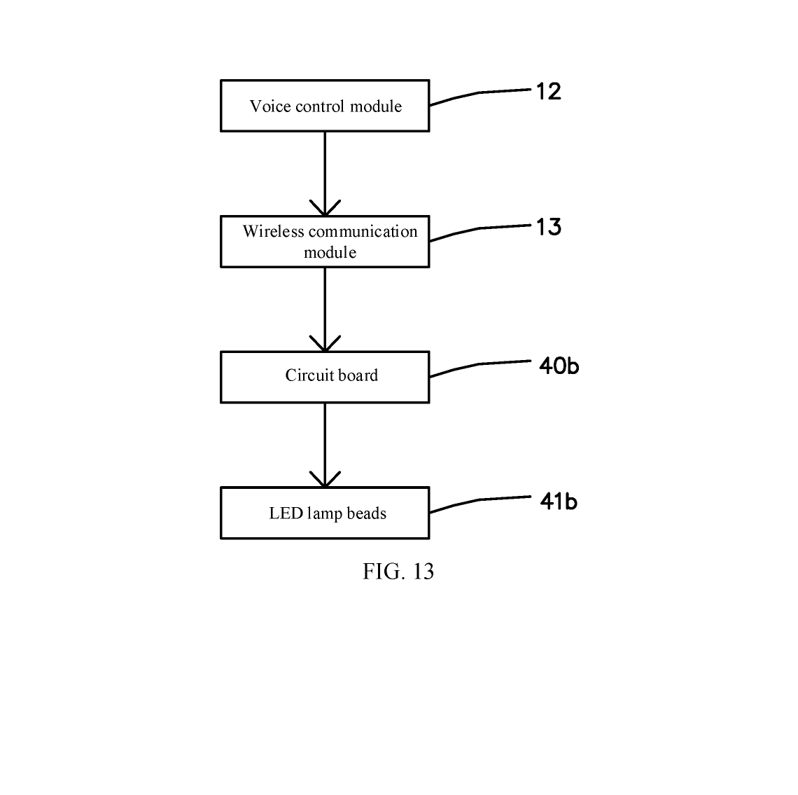

Differing from the first embodiment, as shown in FIG. 13, the fan body 10b further comprises a voice control module 12 and a wireless communication module 13. During operation, a user issues a voice command (such as "turn the light red" or "turn on the light breathing mode"). The voice control module 12 collects and recognizes the voice command and sends the voice command to the LED module 40b through the wireless communication module 13. After a control chip (i.e., the circuit board) of the LED module 40bparses the commands, the control chip drives the LED lamp beads 41b to operate according to preset parameters. The light emitted by the LED lamp beads is transmitted through the light guide elements 30b, presenting a corresponding visual effect when the fan blade structure rotates. For example, when the user issues a voice command, such as "switch the light mode", the LED lamp beads 41b cycles through red, green, blue, and other colors, forming dynamic light through the light guide elements 30b, realizing a function of voice-interactive control of light changes, improving the user experience and an intelligence level of the cooling fan.

It is understood that in other embodiments, the first end of each of the light guide elements 30b passes through the cavity 23b of the central hub 21b and extends along the first surface 225b of the corresponding one of the blades 22b, without passing through the first surface 225b of the corresponding one of the blades 22b, but instead directly forms the corresponding one of the light-emitting points 31 on the first surface 225b of the corresponding one of the blades.

The above-mentioned embodiments only represent some embodiments of the present disclosure. The descriptions thereof are specific and detailed, but should not be construed as a limitation of the scope of the present disclosure. It should be pointed out that for those of ordinary skill in the art, without departing from the concept of the present disclosure, modifications and improvements can be made. The modifications and the improvements belong to the protection scope of the present disclosure. Therefore, the protection scope of the present disclosure should be subject to the attached claims.

What is claimed is:

1. A cooling fan with a luminous effect, comprising:
a fan body;
wherein the fan body comprises a fan blade structure, light guide elements, and a light-emitting diode (LED) module;
wherein the fan blade structure comprises a central hub and blades extending outward from an outer wall of the central hub;
wherein the central hub defines a cavity, and each of the blades comprises a first surface and a second surface disposed opposite to the first surface;
wherein the light guide elements comprises light-emitting points and light-receiving points, and a first end of each of the light guide elements is away from the central hub;
wherein each of the light guide elements extends along the first surface of a corresponding one of the blades, passes through the corresponding one of the blades, and forms a corresponding one of the light-emitting points on the second surface of the corresponding one of the blades;
wherein each of the light-receiving points is disposed on a second end of a corresponding one of the light guide elements, and the second end of each of the light guide elements faces the central hub;
wherein the LED module comprises LED lamp beads, the LED lamp beads are one-to-one corresponding to the light-receiving points of the light guide elements, and the light-receiving points are configured to receive light emitted by the LED lamp beads and transmit the light to the light-emitting points.

2. The cooling fan according to claim 1, wherein the central hub defines notches communicated with the cavity, and each of the notches is configured to accommodate the second end of a corresponding one of the light guide elements.

3. The cooling fan according to claim 1, wherein the first surface of each of the blades is an arc-shaped curved surface, and each of the light guide elements extends along a bending direction of the arc-shaped curved surface of the corresponding one of the blades.

4. The cooling fan according to claim 1, wherein the light guide elements further comprise light shielding sleeves, each of the light shielding sleeves is sleeved on an extension portion of a corresponding one of the light guide elements, and the extension portion of each of the light guide elements is a portion of each of the light guide elements located on the first surface of the corresponding one of the blades.

5. The cooling fan according to claim 1, wherein noise reduction ribs are disposed on the second surface of each of the blades, and the noise reduction ribs on each of the blades are distributed at intervals along an extension direction of each of the blades.

6. The cooling fan according to claim 1, wherein a top portion of each of the blades extends forwardly to form a protrusion portion, each protrusion portion is of a streamlined curved structure, sawtooth structures connected end to end are disposed on one side edge of each of the blades and are adjacent to a corresponding protrusion portion, and the sawtooth structures are disposed on a periphery of each of the blades.

7. The cooling fan according to claim 6, wherein noise reduction ribs are disposed on the second surface of each of the blades, the noise reduction ribs of each of the blades are raised and distributed in an array, and the noise reduction ribs extend along a length direction of each of the blades.

8. The cooling fan according to claim 1, wherein the first surface of each of the blades equipped with a corresponding one of the light guide elements defines a mounting groove, each mounting groove is disposed along an extension direction of a corresponding one of the blades, and each mounting groove is configured to accommodate a corresponding one of the light guide elements and implement light transmission.

9. The cooling fan according to claim 1, wherein the LED module is accommodated in the cavity, the LED module comprises a circuit board and the LED lamp beads mounted on the circuit board, and the LED lamp beads are disposed in an annular array.

10. The cooling fan according to claim 9, wherein the LED lamp beads are disposed on an outer surface of the circuit board away from the cavity.

11. The cooling fan according to claim 9, wherein the LED lamp beads are disposed on an inner surface of the circuit board away from the cavity.

12. The cooling fan according to claim 1, wherein the fan body further comprises a driving module mounted in the cavity, the driving module is configured to drive the fan blade structure to rotate, and the driving module comprises an output shaft connected to the central hub.

13. The cooling fan according to claim 1, wherein the fan body further comprises a fixing bracket;
wherein the fixing bracket comprises a circular base plate, an assembling cylinder, and mounting support arms;
wherein a center of the circular base plate is connected to the assembling cylinder, the assembling cylinder is matched with a driving module, the driving module is axially positioned with the assembling cylinder by an interference fit or a key connection, and the mounting support arms are connected to an outer edge of the circular base plate.

14. The cooling fan according to claim 13, wherein the mounting support arms comprise at least three mounting support arms, the at least three mounting support arms are distributed in a circular array, an end of each of the mounting support arms defines a mounting through hole, and each mounting through hole is configured to be fastened and mounted by a screw.

15. The cooling fan according to claim 13, wherein a snapping structure is disposed on one side of the circular base plate, the snapping structure is configured to connect with an external control circuit board to limit a position of the external control circuit board.

16. A cooling fan with a luminous effect, comprising:
a fan body;
wherein the fan body comprises a fan blade structure, light guide elements and an LED module;
wherein the fan blade structure comprises a central hub and blades extending outward from an outer wall of the central hub;
wherein the central hub defines a cavity, and each of the blades comprises a first surface and a second surface disposed opposite to the first surface;
wherein a first end of each of the light guide elements is away from the central hub, the light guide elements comprises light-emitting points and light-receiving points, and each of the light guide elements extends along the first surface of a corresponding one of the blades to form a corresponding one of the light-emitting points;
wherein the first surface of each of the blades is an arc-shaped curved surface, and each of the light guide elements extends along a bending direction of the arc-shaped curved surface of the corresponding one of the blades;
wherein each of the light-receiving points is disposed on a second end of a corresponding one of the light guide elements, and the second end of each of the light guide elements faces the central hub;
wherein the LED module is accommodated in the cavity, the LED module comprises LED lamp beads, the LED lamp beads are one-to-one corresponding to the light-receiving points of the light guide elements, and the light-receiving points are configured to receive light emitted by the LED lamp beads.
